(19) United States
(12) Patent Application Publication
(10) Pub. No.: US 2011/0078218 A1
(43) Pub. Date: Mar. 31, 2011

(54) EVENT HISTORY STORAGE DEVICE, EVENT HISTORY TRACKING DEVICE, EVENT HISTORY STORAGE METHOD, EVENT HISTORY STORAGE PROGRAM, AND DATA STRUCTURE

(75) Inventors: Norio Hirai, Tokyo (JP); Mitsunori Kori, Tokyo (JP)

(73) Assignee: MITSUBISHI ELECTRONIC CORPORATION, Tokyo (JP)

(21) Appl. No.: 12/919,774

(22) PCT Filed: Feb. 29, 2008
(86) PCT No.: PCT/JP2008/053653

§ 371 Date: Oct. 12, 2010

(51) Int. Cl. G06F 17/30

(52) U.S. Cl. 707/812; 707/E17.044

(57) ABSTRACT

When an instance targeted for tracking is divided or replicated to generate a new instance, ready and continuous tracking of a history of an event related to the original instance and the new instance is allowed. A behavior ID is assigned to an event for each instance, and an occurrence order of the event is managed for each instance. When a new instance has been generated from an instance due to a certain event, a new behavior ID is assigned to the new instance, with respect to that event. Then, the new identifier and an identifier assigned to the instance that is a generation source for the event are associated.

### TECHNICAL FIELD

The present invention relates to a data management technology for readily and efficiently implementing tracking of information included in an operation log of an application and a history tracking technology that uses data managed by the data management technology, for example.

### BACKGROUND ART

Histories of information leakage, unauthorized access, device failure, and the like, centering on the fields of information security, network monitoring, and facilities management, are monitored from collected and stored log data. Information, network, and facilities are thereby highly managed.

History data on events that have occurred on an instance targeted for tracking is collected, and the behavior of the instance is tracked for a certain period, based on the history data on the events, for example. A tracking target is a target for tracking and monitoring, and is a file or the like generated by a PC (Personal Computer), for example. A substance targeted for tracking is referred to as an instance. Specifically, when the tracking target is a file, the instance indicates a specific file such as a file A or a file B. The behavior of the instance is editing and storage of the file A or the like, for example.

Generally, a tracking target ID (identifier) by which an instance related to an event is identified, a time stamp indicating a time at which the event has occurred, and event operation information are recorded in event history data. Specifically, in history data on an event in which “the file A has been edited”, the identifier of the file A, information on a date and time when the editing has been performed, and information indicating the operation of editing are recorded.

In Patent Document 1, a unified identifier is assigned to each instance that has been distributed into and recorded in a plurality of databases, and information indicating the order in which each instance has been processed is held for each instance. This facilitates sequential tracking of a process for each instance even if event history data has been distributed into and recorded in the plurality of databases.

### Patent Document 1: JP11-212831

### DISCLOSURE OF THE INVENTION

### Problems to be Solved by the Invention

In a related art event history management method, when an instance is divided or the like, it is difficult to continuously track the behavior of the instance before the division and behaviors of instances after the division. In other words, when the instance is divided, a new identifier is assigned to a new instance generated by the division. Thus, different identifiers are assigned to the original instance (instance before the division) and the new instance (instance after the division). For that reason, relevance between the original instance and the new instance is eliminated. Thus, it becomes difficult to continuously track the original instance and the new instance. That is, when the new instance is generated from the instance, it is difficult (time consuming and inconvenient) to continuously track the original instance and the new instance.

This difficulty in continuous tracking is not limited to division of the instance. Also when the instance is integrated or replicated, continuous tracking is difficult.

Assume that an instance is a file generated by a PC and the file is copied or renamed, or that the instance is a raw material in a manufacturing process and the material is divided and integrated, for example. Then, it is difficult to continuously track the instance before the process and an instance after the process.

In other words, when a file is copied to generate a new file, different identifiers are assigned to the file of a copy source and the new file. For that reason, it is difficult to continuously track behaviors of the file of the copy source and the new file.

In the related art event history management method, it is difficult (time consuming and inconvenient) to track the operation of a certain instance from a different point of view.

When a plurality of files are present and the files are used by a plurality of users, it is difficult to track the behavior of a certain one of the files from a point of view of a user that has used the file. In order words, tracking of a certain file that has been stored, opened, and then stored again may be performed. However, it is difficult to perform tracking of the certain file stored by user 1, opened by user 2, and then stored by user 2 again.

An object of the present invention is to allow ready and continuous tracking of an event history between an original instance and a new instance even if the new instance is generated from the original instance, for example.

Another object of the present invention is to allow ready tracking of an operation on a certain instance from a different point of view, for example.

### Means for Solution to the Problems

An event history storage device according to the present invention is an event history storage device for storing histories of events which have occurred in an application, for example. The event history storage device may include:

an order relationship storage unit which assigns, for each instance belonging to a class targeted for tracking among classes each indicating a predetermined type, an identifier to an event that has occurred in association with the instance, and stores order-related information in a storage device, an occurrence order of the event which has occurred in association with the instance being represented by the identifier in the order-related information;

a hierarchical relationship storage unit which assigns a new identifier to the event with respect to a new instance when the new instance has been generated from the instance due to the event with the occurrence order thereof stored by the order relationship storage unit, and stores in the storage device hierarchically related information in which the new identifier and the identifier assigned to the event with respect to the instance that is a generation source for the event are associated; and

a related structure storage unit which stores in the storage device related structure information in which identifiers assigned to the same event with respect to the instance belonging to a different class by one of the order relationship storage unit and the hierarchical relationship storage unit are associated.

The hierarchical relationship storage unit sets the new identifier assigned to the new instance as a child and sets the identifier assigned to the instance of the generation source as a parent, and stores the hierarchically related information in which the new identifier and the identifier assigned to the instance of the generation source are associated.

The hierarchical relationship storage unit regards the new instance has been generated when the instance is divided, integrated, or replicated due to the event.

An event history tracking device according to the present invention is an event history tracking device for tracking an event history of a predetermined instance from the event histories stored in the event history storage device, for example. The event history tracking device may include:

a condition input unit which inputs condition information that determines the instance targeted for tracking through an input device;

an order relationship tracking unit which obtains an event that has occurred in association with the instance determined by the condition information input by the condition input unit in an order indicated by the order-related information stored by the order relationship storage unit; and

a hierarchical relationship tracking unit which obtains an instance of a next hierarchy and an event that has occurred in association with the instance of the next hierarchy, the instance of a next hierarchy being a new instance that has been generated from the instance determined by the condition information or an instance from which the instance determined by the condition information has been generated, by tracking an identifier associated by the hierarchical relationship storage unit with an identifier assigned to the event obtained by the order relationship tracking unit.

The condition input unit inputs range information for narrowing down a tracking range to determine a class, together with the condition information; and

the event history tracking device may further includes:

an inter-class relationship tracking unit which obtains a different class instance related to the instance determined by the condition information and belonging to the class determined by the range information and an event that has occurred in association with the different class instance, by tracking an identifier associated by the related structure storage unit with an identifier assigned to the event obtained by the order relationship tracking unit and the hierarchical relationship tracking unit, the identifier being assigned to the instance belonging to the class indicated by the range information.

The hierarchical relationship tracking unit repeats a hierarchical relationship tracking process of obtaining an instance of a further next hierarchy and an event that has occurred in association with the instance of the further next hierarchy, by tracking an identifier associated by the hierarchical relationship storage unit with an identifier assigned to the instance of the next hierarchy.

The condition input unit inputs the condition information and hierarchy information indicating the number of hierarchies to be tracked; and

the hierarchical relationship tracking unit repeats hierarchical relationship tracking processes corresponding to the number of hierarchies indicated by the hierarchy information and then finishes the hierarchical relationship tracking processes.

An event history storage method according to the present invention is an event history storage method of storing histories of events which have occurred in an application, for example. The method may include:

an order relationship storage step of assigning, for each instance belonging to a class targeted for tracking among classes each indicating a predetermined type, an identifier to an event that has occurred in association with the instance by a processing device, and storing order-related information by a storage device, an occurrence order of the event which has occurred in association with the instance being represented by the identifier in the order-related information;

a hierarchical relationship storage step of assigning by the processing device a new identifier to the event with respect to a new instance when the new instance has been generated from the instance due to the event with the occurrence order thereof stored in the order relationship storage step, and storing by the storage device hierarchically related information in which the new identifier and the identifier assigned to the event with respect to the instance that is a generation source for the event are associated; and

a related storage step of storing by the storage device related structure information in which identifiers assigned to the same event with respect to the instance belonging to a different class in one of the order relationship storage step and the hierarchical relationship storage step are associated.

An event history storage program according to the present invention is an event history storage program for storing histories of events which have occurred in an application, for example. The program may cause a computer to execute:

an order relationship storage process of assigning, for each instance belonging to a class targeted for tracking among classes each indicating a predetermined type, an identifier to an event that has occurred in association with the instance, and storing in a storage device order-related information, an occurrence order of the event which has occurred in association with the instance being represented by the identifier in the order-related information;

a hierarchical relationship storage process of assigning a new identifier to the event with respect to a new instance when the new instance has been generated from the instance due to the event with the occurrence order thereof stored in the order relationship storage process, and storing in the storage device hierarchically related information in which the new identifier and the identifier assigned to the event with respect to the instance that is a generation source for the event are associated; and

a related structure storage process of storing in the storage device related structure information in which identifiers assigned to the same event with respect to the instance belonging to a different class in one of the order relationship storage process and the hierarchical relationship storage process are associated.

A data structure according to the present invention is a data structure for storing histories of events which have occurred in an application, for example. The data structure may include:

an instance information storage region including a storage region in which information is stored for each instance belonging to a class targeted for tracking, the class targeted for tracking being one of classes each indicating a predetermined type;

the storage region for each instance including:

a behavior identifier storage region including a storage region for each event which has occurred in association with the instance, the storage region for each event storing a behavior identifier assigned to the instance and an event which has occurred in association with the instance, and at least one of behavior identifiers assigned to events which have occurred in associat ion with the instance before and after the event with the behavior identifier assigned thereto; and

at least one of a child instance storage region and a parent instance storage region, the child instance storage region storing an instance identifier that identifies a new instance generated from the instance and a behavior identifier assigned to the new instance with respect to an event due to which the new instance has been generated, the parent instance storage region storing an instance identifier that identifies the instance from which the new instance has been generated and a behavior identifier assigned to the instance with respect to the event due to which the instance has been generated;

the storage region for each event in the behavior identifier storage region including:

a related structure storage region storing a behavior identifier assigned to an instance belonging to a different class, with respect to the event which has occurred in association with the event.

### EFFECTS OF THE INVENTION

The event history storage device according to the present invention manages an occurrence order of an event by assigning the identifier for each instance. Further, when a new instance has been generated from the instance due to a certain event, the event history storage device assigns a new identifier to the new instance with respect to the event, and associates the new identifier and the identifier assigned to the instance that is a generation source for the event. Accordingly, history of the events (behaviors of the instance) that have occurred in association with the instance may be tracked. In addition, even if a new instance is generated from the instance, the original instance and the new instance may be readily and continuously tracked.

The event history storage device according to the present invention associates the identifier assigned to an instance belonging to a different class with respect to the same event. Accordingly, an operation on a certain instance may be readily tracked from a different point of view.

### BEST MODE FOR CARRYING OUT THE INVENTION

### Embodiment 1

In this embodiment, a method of storing the history of an event that has occurred in a predetermined application will be described.

FIG. 1 is a functional block diagram showing functions of an event history storage device 10 in this embodiment.

The event history storage device 10 includes a history data integration unit 11, a specified condition storage unit 12, an integrated definition storage unit 13, an integrated data storage unit 14, an element extraction unit 15, a class information generation unit 16, an instance information generation unit 17, an order relationship storage unit 18, a hierarchical relationship storage unit 19, a related structure storage unit 20, and a behavior index storage unit 21.

The history data integration unit 11 obtains event history data stored in respective formats of a plurality of event history databases 22, from the respective event history databases 22, and converts the event history data into integrated data of a unified format, based on a condition specified file stored in the specified condition storage unit 12 and an integrated data definition file stored in the integrated definition storage unit 13.

The specified condition storage unit 12 stores in the storage device the condition specified file that specifies a narrowing condition for extracting an instance from information included in the event history data stored in the event history databases 22. The condition specified file specifies a condition such as extraction of only an event related to a file operation, for example. In this case, when the event history data includes names of commands that have been executed, for example, the condition specified file specifies the condition for extracting the event history data in which the name of a command related to the file operation has been stored.

The integrated definition storage unit 13 stores in the storage device the integrated data definition file that defines in which column of the integrated data each item of the event history data extracted based on the condition specified by the condition specified file is stored. In short, the integrated data definition file indicates a correspondence between the column of the event history data of each format and the column of the integrated data, for example.

The integrated data storage unit 14 stores in the storage device the integrated data obtained by the conversion by the history data integration unit 11.

FIG. 2 is a diagram showing an example of the data format of the integrated data.

The integrated data shown in FIG. 2 includes items of header information 110, an event ID120, the number of classes 130, and tracking target information 140.

The header information 110 includes a time stamp 111 and original log specifying information 112. Date and time information on occurrence of an event is stored in the time stamp 111. The original log specifying information 112 stores the database of an extraction source of event history data and a row number (record number) indicating from which record of the database the event history data has been extracted. In short, information indicating from which record of which database the event history data has been extracted is stored in the original log specifying information 112.

An identifier that uniquely identifies the event is stored in the event ID120. The identifier assigned to the event in the database of the extraction source, for example, may be stored in the event ID120.

The number of classes (the number of tracking target information 140, which is n in FIG. 2) included in the record is stored in the number of classes 130.

Information on an instance included in the event is stored in the tracking target information 140. When a plurality of instances are included in one event, information on each of the instances is all stored. The tracking target information 140 includes a tracking target class ID141, a tracking target instance 1D142, the number of children 143, the number of parents 144, and a parent/child instance ID buffer 145 for each instance.

A class ID that uniquely identifies a class to which the instance belongs is stored in the tracking target class ID141. An instance ID that uniquely identifies the instance is stored in the tracking target instance ID142. The number of child instances of the instance is stored in the number of children 143. When no child instance is present for the instance, 0 is stored in the number of children 143. The number of parent instances of the instance is stored in the number of parents 144. When no parent instance is present for the instance, 0 is stored in the number of parents 144. An instance ID of a child instance or a parent instance is stored in the parent/child instance ID buffer 145 when the child instance or the parent instance is present.

The class indicates a predetermined type. The class includes a file class indicating a file, a user class indicating a user, and the like, for example. The instance indicates a substance targeted for tracking. When the instance belongs to the file class, the instance is an actual file such as a file A or a file B. When the instance belongs to the user class, the instance is an actual user such as a user 1 or a user 2.

The child instance is a new instance generated by division, integration, replication, or the like of the instance. Assume that the instance is a file generated by a PC, for example. Then, when the file is copied and a new file is then generated, the new file is the child instance of the file of a copy source. On the other hand, the file of the copy source is the parent instance of the new file.

When the file A is copied to generate the file B, for example and event history data on the file A is tracked, information that “the file A has been copied to generate the file B by the user 1” can be obtained. In other words, when the event history data on the file A is tracked, information that the file B is the child instance of the file A can be obtained. On the other hand, even if event history data on the file B is tracked, the information that “the file A has been copied to generate the file B by the user 1” cannot be obtained. In short, even if the event history data on the file B is tracked, information that the file A is the parent instance of the file B cannot be obtained. That is, the child instance can be known from the parent instance, but the parent instance cannot be known from the child instance. In this case, the number of the child is stored in the number of children 143 of the parent instance, and the instance ID of the child instance is stored in the parent/child instance Id buffer 145 of the parent instance. However, the number of the parent is not stored in the number of patents 144 of the child instance, and the instance ID of the parent instance is not stored in the parent/child instance ID buffer 145 of the child instance, either.

When a message 2 has been returned for a message 1 of an electronic mail, for example, the message 2 is the child instance of the message 1, and the message 1 is the parent instance of the message 2. Information that the message 2 has been returned for the message 1 cannot be obtained from event history data on the message 1. In other words, information that the message 2 is the child instance of the message 1 cannot be obtained from the event history data on the message 1. On the other hand, the information that the message 2 has been returned for the message 1 can be obtained from event history data on the message 2. In other words, information that the message 1 is the parent instance of the message 2 can be obtained from the event history data on the message 2. In this case, the number of child is not stored in the number of children 143 of the parent instance, and the instance ID of the child instance is not stored in the parent/child instance ID buffer 145 of the parent instance. However, the number of the parent is stored in the number of parents 144 of the child instance, and the instance ID of the parent instance is stored in the parent/child instance ID buffer 145 of the child instance.

In short, in integrated data, the ID of a child instance should be held in information on a parent instance, or the ID of the parent instance should be held in information on the child instance. For that reason, even if the child instance can be known from the parent instance but the parent instance cannot be known from the child instance, and even if the parent instance can be known from the child instance but the child instance cannot be known from the parent instance, all event history data can be converted to the format of integrated data.

The element extraction unit 15 reads event history data from the integrated data storage unit 14 one by one, and extracts information necessary for generating a behavior index which will be described later, such as an event ID, a class ID, a tracking target instance ID, and presence or absence of a child-parent relationship, while referring to the integrated data definition file stored in the integrated definition storage unit 13.

The class information generation unit 16 and the instance information generation unit 17 generate fixed information from the information extracted by the element extraction unit 15 and store the generated information in the behavior index storage unit 21.

The order relationship storage unit 18, hierarchical relationship storage unit 19, and related structure storage unit 20 generate data of a graph structure in which an event that has occurred for each instance is associated with a state change (behavior) caused by the event, and stores the data in the behavior index storage unit 21.

The class information generation unit 16, instance information generation unit 17, order relationship storage unit 18, hierarchical relationship storage unit 19, and related structure storage unit 20 will be described later in detail.

FIG. 3 is a diagram showing a structure of a data model managed by the behavior index storage unit 21, using history of operations on an electronic file generated by a predetermined information device (such as the PC) as an example.

FIG. 3 represents a behavior in which the file A has been stored by the user 1, the file A has been copied into a USB (Universal Serial Bus) memory by the user 2, the file A of the copy source has been opened by the user 1, and the user 2 has left the room.

The class information generation unit 16, instance information generation unit 17, order relationship storage unit 18, hierarchical relationship storage unit 19, and related structure storage unit 20 will be described, based on the data format of the integrated data shown in FIG. 2 and the graph structure shown in FIG. 3.

The class information generation unit 16 generates classes constituted from the file class and the user class, based on class IDs stored in the tracking target class IDs 141 of the integrated data.

The instance information generation unit 17 generates instances of the file A and the file B in the file class, and instances of the user 1 and the user 2 in the user class, based on instance IDs stored in the tracking target instance IDs 142 of the integrated data.

The order relationship storage unit 18 generates a history (order-related information) indicating the order of “storage, USB copying, and opening” of the file A, a history (order-related information) indicating the order of “storage and opening” by the user 1, and a history (order-related information) indicating the order of “USB copying and leaving the room” by the user B. That is, the order relationship storage unit 18 generates information indicated by horizontal arrows (directed edges) shown in FIG. 3.

The hierarchical relationship storage unit 19 generates hierarchically related information indicating generation of the file B from the file A due to the event of USB copying. That is, the hierarchical relationship storage unit 19 generates information from the file A to the file B, indicated by an arrow shown in FIG. 3.

The related structure storage unit 20 generates related structure information indicating a corresponding (identical) event relationship between an instance of the file class and an instance of the user class. That is, the related structure storage unit 20 generates information indicated by a broken line arrow between the instance of the file class and the instance of the user class.

The behavior index storage unit 21 stores the information generated by the class information generation unit 16, instance information generation unit 17, order relationship storage unit 18, hierarchical relationship storage unit 19, and related structure storage unit 20 in the storage device as the behavior index.

In other words, the event history storage unit 10 stores history data on an event that has occurred in association with each instance by a graph structure in which a behavior indicating a state change of each instance is associated with the event.

FIG. 4 is a diagram showing a data structure of the behavior index.

In a behavior index 200, a class information table 210 is generated for each class. Specifically, in the example of FIG. 3, the class information table 210 is generated for each of the file class and the user class.

Each class information table 210 includes a class ID211, the number of instances 212, and an instance ID array 213.

The class ID 211 stores a class ID by which the class is identified.

The number of instances 212 stores the number of instances belonging to the class.

In the instance ID array 213, an instance information table 220 (instance information storage region) is generated for each instance belonging to the class.

Specifically, in the file class in FIG. 3, the identifier indicating the file class is stored in the class ID211. The instances are the file A and the file B, which are two files. Thus, “2” is stored in the number of instances 212. The instance information table 220 is generated for each of the file A and the file B.

Each instance information table 220 includes instance header information 221, a behavior ID array 222, a child information management array 223, and a parent information management array 224.

Information such as the instance ID is stored in the instance header information 221.

In the behavior ID array 222, a behavior information table (behavior identifier storage region) 230 indicating information on an event which has occurred in association with the instance is generated. In other words, information on a behavior indicating a change in the state of the instance is stored in the behavior ID array 222.

In the child information management array 223, a child instance information table (child instance storage region) 250 indicating information on a child instance of the instance is generated.

In the parent information management array 224, a parent instance information table 260 (parent instance storage region) indicating information on a parent instance of the instance is generated.

Specifically, in the file A of the file class in FIG. 3, the identifier of the file A is stored in the instance header information 221. Information on each behavior of “storage”, “USB copying”, and “opening” of the file A is stored in the behavior ID array 222. Further, information on the file B, which is the child instance of the file A is stored in the child information management array 223. Further, since no parent instance is present for the file A, information indicating no parent instance is stored in the parent information management array 224. On the other hand, with respect to the file B, the identifier of the file B is stored in the instance header information 221. Information on the behavior of “USB copying” of the file B is stored in the behavior ID array 222. Since no child instance is present for the file B, information indicating no child instance is stored in the child information management array 223. Information on the file A, which is the parent instance of the file B is stored in the parent information management array 224.

Each behavior information table 23 includes a behavior ID 231, an event ID 232, a subsequent behavior ID 233, an immediately preceding behavior ID 234, and an inter-class relationship management array 235.

The ID of a behavior by which that behavior is uniquely identified is stored in the behavior ID 231. The behavior indicates a change in the state of an instance, caused by an event. That is, the behavior occurs for each event and for each instance, and the behavior ID is assigned for each event and for each instance.

The event ID of the event that causes that behavior is stored in the event ID 232.

A behavior ID indicating a behavior that occurs subsequent to that behavior is stored in the subsequent behavior ID 233.

A behavior ID indicating a behavior that has occurred immediately preceding that behavior is stored in the immediately preceding behavior ID 234.

In the inter-class relationship management array 235, a related structure information table (related structure storage region) 240 is generated. The related structure information table 240 indicates information (related structure information) on the behavior of an instance of a different class that has been caused by the event which brought about occurrence of that behavior.

Specifically, with respect to the behavior of “USE copying” of the file A of the file class in FIG. 3, the behavior ID indicating the behavior of “USB copying” of the file A is stored in the behavior ID 231. The event ID indicating the event of “USE copying” is stored in the event ID 232. Further, the behavior ID indicating the behavior of “opening”, which is the behavior subsequent to “USB copying” is stored in the subsequent behavior ID 233. Further, the behavior ID indicating the behavior of “storage”, which is the behavior immediately preceding “USB copying” is stored in the immediately preceding ID 234. Information on a behavior (related behavior) generated in the user class different from the file class to which the file A belongs is stored in the inter-class relationship management array 235. The behavior has been caused by the event that brought about occurrence of the behavior of “USB copying” of the file A. In other words, information on the behavior of “USB copying” by the user 2 is stored in the inter-class relationship management array 235.

The related structure information table 240 includes a class ID 241, an instance ID 242, and a behavior ID 243.

The class ID of the instance for which the related behavior has occurred is stored in the class ID 241.

The instance ID of the instance for which the related behavior has occurred is stored in the instance ID 242.

The behavior ID of the related behavior is stored in the behavior ID 243.

Specifically, with respect to the behavior of “USB copying” by the user 2, which is the behavior related to the behavior of “USB copying” of the file A, the class ID of the user class is stored in the class ID 241. The user ID of the user 2 is stored in the instance ID 242. The behavior ID indicating the behavior of “USE copying” by the user 2 is stored in the behavior ID 243.

The child instance information table 250 includes a child instance ID 251 and a behavior ID 252.

The instance ID of a child instance of the instance is stored in the child instance ID 251.

A behavior ID indicating a behavior of the child instance caused by the event, due to which the child instance has been generated, is stored in the behavior ID 252.

Specifically, for the file A of the file class in FIG. 3, the instance ID indicating the file B, which is the child instance of the file A is stored in the child instance ID 251. The behavior ID indicating the behavior of “USB copying”, by which the file B has been generated and which is the behavior about the file B is stored in the behavior ID 252. That is, the behavior ID indicating the behavior shown by the arrow from the file A to the file B in FIG. 3 is stored in the behavior ID 252.

The parent instance information table 260 includes a parent instance ID 261 and a behavior ID 262.

The instance ID of a parent instance of the instance is stored in the parent instance ID 261.

A behavior ID indicating the behavior of the parent instance caused by the event, due to which the instance has been generated, is stored in the behavior ID 262.

Specifically, for the file B of the file class in FIG. 3, the instance ID indicating the file A, which is the parent instance of the file B, is stored in the parent instance ID 261. The behavior ID indicating the behavior of “USB copying” is stored in the behavior ID 262. The behavior of “USB copying” is the behavior by which the file B has been generated, and is the behavior about the file A. That is, the behavior ID indicating the behavior of USB copying of the file A shown by a horizontal arrow in FIG. 3 is stored in the behavior ID 262.

Next, a behavior index generation process will be described.

First, a process by the class information generation unit 16, instance information generation unit 17, and order relationship storage unit 18 will be described. FIG. 5 is a flowchart showing an order-related information generation process by the class information generation unit 16, instance information generation unit 17, and order relationship storage unit 18.

In the order-related information generation process, one record of integrated data is loaded by the element extraction unit 15. Then, information included in that record is obtained, and the following processes, the number of which corresponds to the number of tracking target information 140 included in that record, are performed. The order-related information generation process is sequentially executed from an immediately preceding record to a subsequent record of the integrated data. That is, the order-related information generation process is sequentially executed from the record on an event that has occurred earlier to the record on an event that has occurred later. By executing the order-related information generation process, information on respective classes, information on respective instances, and information on the order of behaviors of the respective instances (indicated by the horizontal arrows) shown in FIG. 3 are generated.

(S101): The element extraction unit 15 obtains the number of classes (the number of the tracking target information 140) stored in the number of classes 130 from an earliest one of unprocessed records of the integrated data.

(S102): The element extraction unit 15 determines whether or not processes on all the tracking target information 140 have been executed, based on the number of classes obtained in step (S101). When the element extraction unit 15 determines that the processes on all the tracking target information 140 have been executed (YES in S102), the procedure is completed. On the other hand, when the element extraction unit 15 determines that the processes on all the tracking target information 140 have not been executed (NO in step S102), the procedure proceeds to step (S103).

(S103): The element extraction unit 15 obtains the class ID stored in the tracking target class ID 141 of the tracking target information 140 for which the process has not been finished.

(S104): The class information generation unit 16 determines whether or not a process on the class ID obtained in step (S103) has been finished, or the class information table 210 on the class ID has been generated. When the class information generation unit 16 determines that the process on the class ID has been finished (YES in step S104), the procedure proceeds to step (S107). On the other hand, when the class information generation unit 16 determines that the process on the class ID has not been finished (NO in step S104), the procedure proceeds to step (S105).

(S105): The class information generation unit 16 generates the class information table 210 on the class ID obtained in step (S103).

(S106): The class information generation unit 16 stores information in the class information table 210 generated in step (S105). As initial information, the class information generation unit 16 stores information in the class ID 211 alone, stores 0 in the number of instances 212, and stores NULL in the instance ID array 213.

(S107): The element extraction unit 15 obtains the instance ID stored in the tracking target instance ID 142 of the tracking target information 140 (from which the class ID has been obtained in step (S103)).

(S108): The instance information generation unit 17 determines whether or not a process on the instance ID obtained in step (S107) has been finished, or the instance information table 220 on the instance ID has been generated. When the instance information generation unit 17 determines that the process on the instance ID has been finished (YES in step S108), the procedure proceeds to step (S111). On the other hand, when the instance information generation unit 17 determines that the process on the instance ID has not been finished (NO in step S108), the procedure proceeds to step (S109).

(S109): The instance information generation unit 17 generates the instance information table 220 on the instance ID obtained in step (S107).

(S110): The instance information generation unit 17 stores information in the instance header information 221 of the instance information table 220 generated in step (S109). Together with the storage, the instance information generation unit 17 increments the number of instances in the number of instances 212 by one.

(S111): The order relationship storage unit 18 generates the behavior information table 230 for the instance ID obtained in step (S107).

(S112): The order relationship storage unit 18 obtains the event ID stored in the event ID 120 of this record, and generates the behavior ID for the instance ID with respect to the event indicated by this event ID. Then, the order relationship storage unit 18 stores the generated behavior ID in the behavior ID 231 and stores the event ID in the event ID 232.

(S113): The order relationship storage unit 18 stores the behavior ID for an immediately preceding behavior in the immediately preceding behavior ID 234 of the behavior information table 230 being currently processed. That is, the order relationship storage unit 18 stores in the immediately preceding behavior ID 234 the behavior ID for the behavior immediately preceding the behavior indicated by the behavior ID stored in step (S112). The order relationship storage unit 18 may search for the behavior information table 230 arranged last in the behavior ID array 222 of the instance information table 220 being currently processed, and obtains the behavior ID stored in the behavior ID 231 of the behavior information table 230, for example. The behavior ID for the immediately preceding behavior may be thereby obtained.

(S114): The order relationship storage unit 18 stores 0 in the subsequent behavior ID 233 of the behavior information table 230 being currently processed. 0 stored in the subsequent behavior ID indicates that no subsequent behavior is present, or this behavior information table 230 is about the behavior that has occurred last.

(S115): The order relationship storage unit 18 stores the current behavior ID generated in step (S112) in the subsequent behavior ID 233 of the behavior information table 230 arranged last.

(S116): The behavior information table 230 being currently processed is added, arranged last in the behavior ID array 222.

In short, the order relationship storage unit 18 assigns an identifier to an event that has occurred in association of each instance belonging to a class targeted for tracking from among classes indicating a predetermined type, and stores order-related information in the storage device. The occurrence order of the event which has occurred in association with the instance is represented by the identifier in the order-related information.

Next, a process by the hierarchical relationship storage unit 19 will be described. FIG. 6 is a flowchart showing a hierarchically related information generation process by the hierarchical relationship storage unit 19.

Herein, the hierarchically related information generation process is executed, following the order-related information generation process described based on FIG. 5. In other words, following completion of the order-related information generation process for one record, a step (S201) that will be described below is executed. In this case, in the step (S201) that will be described below, it is assumed that information is obtained from the tracking target information 140 in the record targeted in the order-related information generation process. The hierarchically related information generation process does not need to be executed following completion of the order-related information generation process for one record. However, the behavior information table 230 on a parent side needs to be generated by the order-related information generation process.

By executing the hierarchically related information generation process on each record of the integrated data, information on a behavior which connects the instances in the same class shown in FIG. 2 (indicated by the oblique solid line arrow) is generated.

(S201): The element extraction unit 15 obtains a value stored in the number of children 143 in the predetermined tracking target information 140 in the predetermined record.

In the following description, the predetermined record is referred to as the record being currently processed, while the instance ID stored in the tracking target instance ID142 of the predetermined tracking target information 140 is referred to as the instance ID being currently processed. The class information table 210 identified by the class ID stored in the tracking target class ID141 in the predetermined tracking target information 140 is referred to as the class information table 210 being currently processed. The instance information table 220 determined by the instance ID being currently processed is referred to as the instance information table 220 being currently processed.

(S202): The hierarchical relationship storage unit 19 determines whether or not a child instance is present for that instance, based on the value obtained in step (S201). In other words, the hierarchical relationship storage unit 19 determines that no child instance is present when the obtained value is 0. Otherwise, the hierarchical relationship storage unit 19 determines that the child instance is present. When the hierarchical relationship storage unit 19 determines that the child instance is present (YES in step S202), the procedure proceeds to step (S203). On the other hand, when the hierarchical relationship storage unit 19 determines that no child instance is present (NO in step S202), the procedure is finished.

(S203): The hierarchical relationship storage unit 19 obtains the instance ID of the child instance stored in the parent/child instance ID buffer 145.

(S204): The hierarchical relationship storage unit 19 determines whether or not the instance information table 220 about the instance ID of the child instance obtained in step (S203) is already present. When the hierarchical relationship storage unit 19 determines that the instance information table 220 is already present (YES in step S204), the procedure proceeds to step (S206). On the other hand, when the hierarchical relationship storage unit 19 determines that the instance information table 220 is not present yet (NO in step S204), the procedure proceeds to step (S205).

(S205): The hierarchical relationship storage unit 19 generates the instance information table 220 about the instance ID of the child instance in the instance ID array 213 of the class information table 210 being currently processed. Then, the hierarchical relationship storage unit 19 stores the instance ID of the child instance in the instance header information 221 of the generated instance information table 220.

(S206): The hierarchical relationship storage unit 19 generates the parent instance information table 260 at the end of the parent information management array 224 of the instance information table 229 generated in step (S205). Then, the hierarchical relationship storage unit 19 stores in the parent instance ID 261 of the generated parent instance information table 260 the instance ID being currently processed, and stores in the behavior ID 262 the behavior ID for the instance being processed with respect to the event in the record being currently processed. This behavior ID has already been generated in the order-related information generation process.

The hierarchical relationship storage unit 19 generates the behavior information table 230 at the end of the behavior ID array 222 of the instance information table 220 about the child instance generated in step (S205). The hierarchical relationship storage unit 19 generates the behavior ID for the child instance with respect to the event in the record being currently processed, and stores the behavior ID in the behavior ID 231 of the generated behavior information table 230. The hierarchical relationship storage unit 19 stores the event ID of the event in the event ID 232. Further, the hierarchical relationship storage unit 19 stores zero in the subsequent behavior ID 233 and the immediately preceding ID 234.

(S207): The hierarchical relationship storage unit 19 generates the child instance information table 250 about the child instance at the end of the child information management array 223 of the instance information table 220 being currently processed. Then, the hierarchical relationship storage unit 19 stores the instance ID of the child instance in the child instance ID 251 of the child instance information table 250, and stores in the behavior ID 252 the behavior ID generated in step (S206).

(S208): The hierarchical relationship storage unit 19 determines whether or not processes corresponding to the number of child instances indicated by the value obtained in step (S201) have been executed. When the hierarchical relationship storage unit 19 determines that the processes corresponding to the number of child instances have been executed (YES in step S208), the procedure is finished. On the other hand, when the hierarchical relationship storage unit 19 determines that the processes corresponding to the number of child instances have not been executed (NO in step S208), the procedure is returned to step (S203).

The above processes were described, using as an example a case where the child instance can be known from the parent instance. However, even when the parent instance can be known from the child instance as well, the hierarchically related information generation process may be implemented by execution of processes based on a similar concept by replacing the parent instance by the child instance and replacing the child instance by the parent instance.

In short, the hierarchical relationship storage unit 19 assigns a new identifier to a new instance with respect to an event when the new instance has been generated from the instance due to the event with the occurrence order thereof stored in the order relationship storage unit 18, and stores hierarchically related information in the storage device. The new identifier and the identifier assigned to the instance that is a generation source for the event are associated in the hierarchically related information.

Further, the hierarchical relationship storage unit sets the new identifier assigned to the new instance as a child and sets the identifier assigned to the instance of the generation source as a parent, and stores the hierarchically related information in which the new identifier and the identifier assigned to the instance of the generation source are associated.

Next, a process by the related structure storage unit 20 will be described. FIG. 7 is a flowchart showing a related structure information generation process by the related structure storage unit 20.

Herein, the hierarchically related information generation process is executed following the order-related information generation process and the hierarchically related information generation process described based on FIGS. 5 and 6. Specifically, following completion of the hierarchically related information generation process for one record, step (S301) which will be described below is executed. In this case, information is obtained from the record targeted in the order-related information generation process and the hierarchically related information generation process in step (S301). The step (S301) which will be described below does not need to be executed, following completion of the hierarchically related information generation process for the one record. However, be fore the related structure information generation process, information on each class, information on each instance, information on the order of the behavior of each instance, and information on a behavior connecting the instances in the same class need to have been generated by the order-related information generation process and the hierarchically related information generation process.

By executing the related structure information generation process on each record of the integrated data, information on the relationships of the instances (indicated by broken line arrows) between the classes shown in FIG. 2 is generated.

(S301): The related structure storage unit 20 determines whether or not an instance belonging to a different class is present in one record obtained from the integrated data. The element extraction unit 15 obtains the class IDs stored in the tracking target class IDs 141 of all the tracking target information 140 of the record, for example. Then, the related structure storage unit 20 determines whether or not the ID of a different class is present in the class IDs obtained by the element extraction unit 15, thereby determining whether or not the instance belonging to the different class is present. When the related structure storage unit 20 determines that the instance belonging to the different class is present (YES in step S301), the procedure proceeds to step (S302). On the other hand, when the related structure storage unit 20 determines that no instance belonging to the different class is present (NO in step S301), the procedure is finished.

(S302): The element extraction unit 15 obtains the class ID and the instance ID stored in the tracking target class ID 141 and the tracking target instance ID 142 of the tracking target information 140 belonging to the different class of the integrated data. In other words, when two tracking target information 140 is present in one record of the integrated data and respectively belongs to the different classes, the element extraction unit 15 obtains the class ID and the instance ID from each tracking target information 140.

(S303): The related structure storage unit 20 generates the related structure information table 240 at the end of the interclass relationship management array 235 of the behavior information table 230 registered in the behavior ID array 222 of the instance information table 220 determined by each instance ID obtained in step (S302). The behavior information table 230 is about the event ID stored in the event ID120 of the event being currently processed. Specifically, when the record of the event of “storage” in FIG. 3 is obtained, the related structure storage unit 20 generates the related structure information table 240 in each of the inter-class relationship management array 235 of the behavior information table 230 with respect to the “storage” event in the instance information table 220 about the file A and the inter-class relationship management array 235 of the behavior information table 230 with respect to the “storage” event in the instance information table 220 about the user 1. The related structure storage unit 20 then stores the class ID, instance ID, and behavior ID of the instance belonging to the different class obtained in step (S302) in the class ID 241, instance ID 242, and behavior ID 243 of each of the generated related structure information tables 240. Specifically, when the record of the event of “storage” in FIG. 3 is obtained, the related structure storage unit 20 stores the class ID of the “user class” of the user 1, the instance ID of the “user 1”, and the behavior ID of the user 1 about the storage in the inter-class relationship management array 235 of the file A. The class ID of the “file class” of the file A, the instance ID of the “file A”, and the behavior ID of the file A about the storage are stored in the inter-class relationship management array 235 of the user 1.

In short, the related storage unit stores related structure information in the storage unit. In the related structure information, an identifier assigned to an instance belonging to a different class by one of the order relationship storage unit and the hierarchical relationship storage unit for the same event is associated.

By the above-mentioned order-related information generation process, hierarchically related information generation process, and related structure information generation process, a behavior index is generated, and the generated behavior index is stored in the behavior index storage unit 21.

As described above, according to the event history storage unit 10 in this embodiment, history data on events that have occurred in association with an instance is represented as an instance behavior graph structure. By tracking the behavior graph structure, history of the events (behaviors of the instance) that have occurred in association with the instance may be tracked. In addition, even if a new instance is generated from the instance, the original instance and the new instance may be readily and continuously tracked.

Similarly, the event history storage unit 10 associates the identifier assigned to an instance belonging to a different class with respect to the same event. Accordingly, an operation on a certain instance (file) may be readily tracked from a different point of view of the different class (user).

### Embodiment 2

In this embodiment, a method of tracking an event history using the behavior index stored in the event history storage device 10 described in Embodiment 1 will be described.

FIG. 8 is a functional block diagram showing a function of an event history tracking device 30 according to this embodiment. The event history tracking device 30 includes an order relationship tracking unit 31, a hierarchical relationship tracking unit 32, and an inter-class relationship tracking unit 33.

The order relationship tracking unit 31 tracks the order of occurrence of an event that has occurred in association with an instance, using a processing device, based on order-related information (context of the behavior ID) determined from the instance ID and the class ID specified as a tracking condition. In other words, the order relationship tracking unit 31 obtains and tracks the event that has occurred in association with the instance determined by condition information supplied by a condition input unit 34, in the order indicated by the order-related information stored in the order relationship storage unit 18.

The hierarchical relationship tracking unit 32 tracks a child instance or a parent instance of the instance, based on hierarchically related information. In other words, by tracking the behavior identifier assigned to the event obtained by the order relationship tracking unit 31 and the behavior identifier associated by the hierarchical relationship storage unit, the hierarchical relationship tracking unit 32 obtains an instance of a next hierarchy and an event that has occurred in association with the instance of the new hierarchy. The instance of a next hierarchy is a new instance that has been generated from the instance determined by the condition information or an instance from which the instance determined by the condition information has been generated. Further, the order relationship tracking unit 31 tracks the occurrence order of the event with respect to the child instance or the parent instance tracked by the hierarchical relationship tracking unit 31, using the processing device, based on an order-related structure.

The inter-class relationship tracking unit 33 tracks the instance ID and the behavior ID of an instance belonging to a different class, which is associated with the behavior ID tracked by the order relationship tracking unit 31, thereby tracking the instance belonging to the different class, using the processing device. In other words, by tracking the behavior identifier associated by the related structure storage unit 20 with the behavior identifier assigned to the event obtained by the order relationship tracking unit 31 and the hierarchical relationship tracking unit 32 and assigned to the instance belonging to the class specified as a tracking range, the inter-class relationship tracking unit 33 obtains and tracks the instance of the different class and an event that has occurred in association with the instance of the different class. The instance of the different class is the instance which is related to the instance determined by the condition information and belongs to the class specified as the tracking range.

The condition input unit 34 inputs the condition information that determines the instance targeted for tracking and information on a range (tracking range) for narrowing down the tracking range through an input device.

Herein, an event history tracking process will be described, using an example of an e-mail transmission/reception history.

FIG. 9 is a diagram of an image of the e-mail transmission/reception history.

FIG. 9 represents a behavior in which a user A transmits a message 1 to a user B and a user C (as indicated by reference numeral (1), and next, the user B transmits a message 2 to the user A as a return of the message 1.

As an ID for identifying a message and an ID for identifying a user, a message ID and a mail address from which uniqueness can be ensured should be originally used. However, abstract representation is made.

FIG. 10 is a diagram showing a data model of a behavior index generated by the event history storage device 10, described in Embodiment 1, for data on the e-mail transmission/reception history shown in FIG. 9.

Referring to FIG. 10, classes targeted for tracking in the e-mail transmission/reception history are a message class and a user class. In the message class, the message 1 and the message 2 are present as instances. In the user class, the user A, the user B, and the user C are present as instances. The data model structure of behaviors generated by these instances is represented as a graph structure.

Next, the event history tracking process in which an event history is tracked based on the behavior index will be described. FIG. 11 is a flowchart showing the event history tracking process by the event history tracking device 30.

(S401): The condition input unit 34 inputs the tracking condition. As the tracking condition, the condition input unit 34 inputs the class ID and the instance ID which specify data targeted for tracking, and a class ID which specifies a tracking range. As the tracking condition, the instance ID (herein the message 1) which uniquely identifies a mail message is specified, and the user class as the tracking range is specified, for example. It is tracked to whom the message 1 specified by this tracking condition has been distributed. Herein, one class is specified as the tracking range. A plurality of classes may also be specified as the tracking range.

(S402): The order relationship tracking unit 31 determines the instance information table 220 about an instance that will be tracked, based on the class ID and the instance ID input in step (S401).

(S403): The order relationship tracking unit 31 determines the behavior information table 230 registered at the head of the behavior ID array 222 of the instance information table 220 determined in step (S402).

(S404): The order relationship tracking unit 31 obtains behavior information stored in the behavior information table 230 determined in step (S403).

(S405): The inter-class relationship tracking unit 33 searches for the related structure information table 240 in which the class ID specified as the tracking range is stored in the class ID 241, from the related structure information tables 240 registered in the inter-class relationship management array 235 of the behavior information table 230 obtained in step (S403). Then, the inter-class relationship tracking unit 33 obtains the instance ID stored in the instance ID 242 and the behavior ID of the searched related structure information table 240.

In the example shown in each of FIGS. 9 and 10, for example, the user A, which is the instance belonging to the class different from the message class and is associated with the first behavior of “transmission” of the message 1 specified as the tracking condition, and the behavior of “transmission” are obtained. Specifically, information that the message 1 has been transmitted by the user A is obtained.

(S406): The order relationship tracking unit 31 determines whether or not behavior information has been obtained from all the behavior information tables 230 in the behavior ID array 222 of the instance information table 220 determined in step (S402). When the order relationship tracking unit 31 determines that the behavior information has been obtained from all the behavior information tables 230 (YES in step S406), the procedure proceeds to step (S408). On the other hand, when the order relationship tracking unit 31 determines that the behavior information has not been obtained from all the behavior information tables 230 (NO in step S406), the procedure proceeds to step (S407).

(S407): The order relationship tracking unit 31 determines a subsequent one of the behavior information tables 230, based on the subsequent behavior ID 233 of the behavior information table 230 being currently processed. Then, the procedure is returned to step (S404), and the behavior information is obtained from the determined subsequent information table 230. The inter-class relationship tracking unit 33 obtains the instance ID and the behavior ID of the class specified as the tracking range, from the related structure information tables 240 registered in the inter-class relationship management array 235 of the subsequent behavior information table 230.

In the example shown in each of FIGS. 9 and 10, for example, the user B, which is the instance belonging to the different class and is associated with the subsequent behavior of “reception” with respect to the message 1 specified as the tracking condition, the behavior of “reception”, the user C, and the behavior of “reception” are obtained. In short, information that the message 1 has been received by the user B and the user C is obtained. Then, no subsequent behavior is present for the message 1. Thus, the answer is YES in step S406, and the procedure proceeds to step (S408).

(S408): The hierarchical relationship tracking unit 32 refers to the child information management array 223 of the instance information table 220 determined in step (S402), and determines whether or not a child instance which has been generated from this instance is present. When the hierarchical relationship tracking unit 32 determines that the child instance is present (YES in step S408), the procedure proceeds to step (S409). On the other hand, when the hierarchical relationship tracking unit 32 determines that the child instance is not present (NO in step S408), the procedure is finished.

(S409): The hierarchical relationship tracking unit 32 obtains the instance ID stored in the child instance ID 251 of the child instance information table 250 in the child information management array 223. Then, the procedure is returned to step (S402), and the tracking process is executed, using the class ID input in step (S401) and the obtained instance ID as a tracking condition. When a plurality of the child instance information tables 250 are registered in the child information management array 223, the tracking process is executed using the instance ID stored in the child instance ID 251 of each child instance information table 250.

In the example shown in each of FIGS. 9 and 10, for example, the message 2 is registered as the child instance of the message 1 specified as the tracking condition. Then, the tracking process is executed using the message 2 as the tracking condition. Then, the user B, which is the instance belonging to the class different from that for the message 2 and is associated with the first behavior of “transmission” of the message 2, and the behavior of “transmission” are obtained. In short, information that the user B has transmitted the message 2 is obtained. Then, the user A, which is the instance belonging to the class different from the class for the message 2 and is associated with the subsequent behavior of “reception” of the message 2, and the behavior of “reception” are obtained. In short, information that the user A has received the message 2 is obtained. Then, no subsequent behavior is present for the message 2 (YES in step S406), and the procedure proceeds to step (S408). Since no child instance is present for the message 2, the procedure is finished.

In the above-mentioned example, the IDs of the message specified as the tracking condition indicated the instance which had been transmitted first and was the root of the graph structure. For that reason, it was enough for the hierarchical relationship tracking unit 32 to execute the child instance tracking process without executing a parent instance tracking process. However, when the message 2 was specified as the instance targeted for tracking, no information cannot be obtained from child instance tracking. On the other hand, the parent instance is present for the message 2. Thus, the parent instance tracking process is needed.

In short, it is necessary for the hierarchical relationship tracking unit 32 to trace the hierarchical relationship of a parent instance to obtain an instance that becomes a root (message 1 in FIG. 10) and track the obtained root message according to the procedure of FIG. 11. The instance that becomes the root is defined as an instance having no parent instance.

Next, a procedure of tracing the hierarchical relationship of the parent instance to obtain the instance that becomes the root will be described. FIG. 12 is a flowchart showing a process of obtaining the instance that becomes the root.

(S501): The order relationship tracking unit 31 determines the instance information table 220 about an instance targeted for tracking, as in steps (S401) and (S402).

(S502): The order relationship tracking unit 31 determines whether or not a parent instance from which this instance has been generated is present, by referring to the parent information management array 224 of the instance information table 220 determined in step (S501). When the order relationship tracking unit 31 determines that the parent instance is present (YES in step S502), the procedure proceeds to step (S503). On the other hand, when the order relationship tracking unit 31 determines that no parent instance is present (NO in step S502), the procedure proceeds to step (S505).

(S503): The hierarchical relationship tracking unit 32 obtains the instance ID stored in the parent instance ID 261 of the parent instance information table 260 registered in the parent information management array 224.

(S504): The hierarchical relationship tracking unit 32 sets the instance ID obtained in step (S503) as the ID of the instance targeted for tracking. Then, the procedure is returned to step (S502), for repetition.

(S505): The hierarchical relationship tracking unit 32 determines that instance as the root, and the procedure is finished.

The instance that becomes the root is determined by the above-mentioned process. Then, by specifying the instance that becomes the root and executing the event history tracking process described based on FIG. 11, any event may be tracked.

When a plurality of the parent instance information tables 260 are registered in the parent information management array 224 in step (S503), the instance ID stored in the parent instance ID 261 of each parent instance information table 260 is obtained. Then, the process of searching for the parent instance for each instance ID is performed. In short, a plurality of instances that becomes roots may be present. In this case, the event history tracking process described based on FIG. 11 is executed, starting from each of the instances that become the roots.

The step of obtaining behavior information is herein omitted so as to obtain the instance that becomes the root. When the behavior information is necessary, parent behavior information may be obtained by the procedure similar to that of obtaining the child ID.

As described above, according to the event history tracking device 30 in this embodiment, the history of events (behaviors of the instance) that have occurred in association with an instance may be tracked from event history data represented as an instance behavior graph structure and stored by the event history storage device 10. In addition, even if a new instance is generated from an original instance, the original instance and the new instance may be readily and continuously tracked.

Similarly, according to the event history tracking device 30, an operation about a certain instance (such as the message 1) may be readily tracked from a point of view of a different instance (user).

### Embodiment 3

In this embodiment, an example of an event history tracking process different from that in Embodiment 2 will be described. In this embodiment in particular, a description will be directed to the tracking process in which a level of a hierarchy to be tracked has been specified.

Herein, the hierarchy indicates a parent-child relationship of instances, and the hierarchical level indicates how many hierarchies the instances are separated. Specifically, the child instance of a predetermined instance is separated from the predetermined instance by 1 hierarchy (1 level). The child instance of the above-mentioned child instance is separated from the predetermined instance by 2 hierarchies (2 levels). Similarly, the parent instance of the predetermined instance is separated from the predetermined instance by −1 hierarchy (−1 level). The parent instance of the above-mentioned parent instance is separated from the predetermined instance by −2 hierarchies (−2 levels).

FIG. 13 is a diagram of an image of a manufacturing process.

Referring to FIG. 13, the manufacturing process includes three steps of a stirring step, a combustion step, and a cooling step. In each step, a production unit number (batch number) which uniquely identifies a production unit is assigned. In the stirring process, stirring 1 is the production unit number. In the combustion process, combustion 1 to combustion n are production unit numbers. In the cooling step, cooling 1 to cooling n are production unit numbers.

Association of the production unit numbers before and after each step (such as the stirring 1 and the combustion 1) is managed by a system. As the structure of a behavior index, each step corresponds to a class, while each product ion unit number corresponds to an instance.

Referring to FIG. 13, the step subsequent to the combustion step is the cooling step. Following the combustion 1, the process proceeds to the cooling 1. A portion of materials of the combustion 1 is returned to the combustion step again for a recycling process, and is passed on to the combustion 2. In the case of such an operation, the combustion 1 and the combustion 2 are managed as a hierarchically related structure of the behavior index. Specifically, the combustion 2 is managed as the child instance of the combustion 1 (instance), while the combustion 3 is managed as the child instance of the combustion 2.

Specifically, the combustion 3 is separated from the combustion 2 by 1 hierarchy (1 level). The combustion 4 is separated from the combustion 2 by 2 hierarchies (2 levels). Similarly, the combustion 1 is separated from the combustion 2 by −1 hierarchy (−1 level).

Herein, assume that when a certain production unit number is specified and the instance is tracked from an upstream step to a downstream step or from the downstream step to the upstream step, tracking to a level specified in advance is performed and tracking to a level deeper than the specified level is terminated, without tracking all information. In such tracking, the tracking is executed by specifying a hierarchy level as a tracking range.

Next, a description will be directed to the event history tracking process in which an event history is tracked up to the specified hierarchy level based on the behavior index. FIG. 14 is a flowchart showing the event history tracking process in which the event history is tracked up to the specified hierarchy level.

(S601): The condition input unit 34 inputs a tracking condition. As the tracking condition, the condition input unit 34 inputs the class ID and the instance ID which specify data targeted for tracking, the class ID which specifies a tracking range, and the hierarchy level for tracking. The condition input unit 34 specifies the instance ID (herein the combustion 2) which uniquely identifies the production unit number, the class of combustion as the tracking range, and a hierarchical level n (herein n=2), for example, as the tracking condition.

(S602): The hierarchical relationship tracking unit32 sets zero to a value D indicating a current hierarchy level. The value indicating the hierarchical level is dynamically calculated at a time of tracking in this manner, without being fixedly held inside the behavior index. With this arrangement, updating of the behavior index is extremely facilitated.

(S603): The order relationship tracking unit 31 determines the instance information table 220 about the instance, based on the class ID and the instance ID input in step (S601).

(S604): The processes from step (S403) to step (S407) are executed.

(S605): The hierarchical relationship tracking unit 32 compares the hierarchy level n specified as the condition with the value D indicating the current hierarchical level, and determines whether or not D z n. When it is determined that D≧n (YES in step S605), the procedure is finished. On the other hand, when it is determined not to be D≧n (NO in step S605), the procedure proceeds to step (S606).

(S606): The hierarchical relationship tracking unit 32 refers to the child information management array 223 of the instance information table 220 determined in step (S602), and determines whether or not a child instance which has been generated from this instance is present. When the hierarchical relationship tracking unit 32 determines that the child instance is present (YES in step S606), the procedure proceeds to step (S607). On the other hand, when the hierarchical relationship tracking unit 32 determines that the child instance is not present (NO in step S606), the procedure is finished.

(S607): The hierarchical relationship tracking unit 32 adds (increments) one to the value D indicating the current hierarchy level.

In the example shown in FIG. 13, for example, the hierarchy level was specified as two as the condition. Thus, tracking is performed up to the combustion 4, which is two hierarchies under the combustion 2 specified as the instance. Tracking of a hierarchy under the combustion 4 (combustion 5 or thereafter) is not performed.

When the instance ID of the combustion 2 is specified as the instance ID and ±1 is specified as the hierarchy level at which tracking is terminated, the combustion 1 and the combustion 3 are tracked.

In the procedure in FIG. 14, the process procedure was described, assuming that the value which gives the specified hierarchy level was positive. Assume that the value is negative and parent instance tracking is performed. Then, by decreasing (decrementing) one in step (S607) and determining whether or not a parent is present in step (S606), the tracking at a specified hierarchy level may be performed.

As described above, according to the event history tracking device 30 in this embodiment, tracking may be performed by limiting the level of a hierarchy to be tracked.

In the above-mentioned embodiments, the descriptions were given using data on histories such as file operations, e-mail transmission and reception, and the manufacturing process as the examples. The invention is not limited to these histories. The invention may be applied to tracking of any event history such as tracking of a human action pattern using an entry and exit log and tracking of a communication path using a network communication log, as well.

The above description is summarized as follows.

The device of processing a plurality of stored history data in the history tracking type data management system in the above-mentioned embodiments includes:

instance extraction means for extracting one or more instances included in one unit of the history data;

order-related structure management means for managing an order relationship of the one or more instances caused by an event that has occurred for the one or more instances extracted by the instance extraction means;

hierarchically related structure management means for managing a hierarchical relationship of the one or more instances when the one or more instances are integrated or divided in the event that has occurred; and

inter-class related structure management means for managing association between a plurality of the instances which belong to different classes when the plurality of the instances belonging to the different classes are related to the event that has occurred.

The history tracking type data management system in the above-mentioned embodiments further includes history data integration means for integrating the history data into data of the unified data format specified in the definition file in advance.

The history data integration means includes an instance narrowing-down function of generating only a necessary target into the integrated data from among all the history data by specifying an instance condition and the like in the definition file in advance.

The history tracking type data management system in the above-mentioned embodiment further includes element extraction means for extracting from the history data an individual instance and an operation which has occurred on the instance.

The order-related structure management means includes a behavior management function for managing events which have occurred on all instances and states of the instances in the form of tables, adding to the tables behavior IDs capable of being uniquely identified, and managing the context of each behavior ID.

The hierarchically related structure management means includes a parent ID identification function, a child ID identification function, and a hierarchical information management function. Assume that a certain event performs instance division, integration, or replication in a same class. Then, in a relationship generated between different instances, the parent ID identification function identifies an instance before occurrence of the event as a parent, the child ID identification function identifies an instance after occurrence of the event as a child, and the hierarchical information management function manages the event of the instance associated with the ID of the parent or child.

The inter-class related structure management means includes an inter-class management function of associating and managing behaviors of a plurality of instances belonging to the different classes when the plurality of instances belonging to the different classes are associated with a certain event at a time of occurrence of the certain event.

The history tracking type data management system further includes behavior index generation means for generating three related structures generated by the order-related structure management means, the hierarchically related management means, and the inter-class related structure management means, as the behavior index.

The history tracking type data management system in the above-mentioned embodiment further includes order relationship tracking means for tracking the behavior of a specified instance based on the instances of which the order relationship managed by the behavior index has been specified, hierarchical relationship tracking means for tracking a hierarchical relationship based on a hierarchical structure relationship, and inter-class tracking means for performing tracking based on an inter-class relationship between different classes.

The inter-class relationship tracking means includes a tracking range specifying function of specifying a plurality of classes that become ranges to be tracked, by an input of a user, and a tracking range class limiting function of limiting only a class in a specified range and performing tracking in the limited class.

The hierarchical relationship tracking means includes a level specifying function of specifying a hierarchy level by an input of the user and a limited hierarchical level tracking function of limiting a tracking range within a hierarchy of a specified level.

Next, a hardware configuration of the event history storage device 10 and the event history tracking device 30 in the above-mentioned embodiments will be described.

FIG. 15 is a diagram showing an example of the hardware configuration of the event history storage device 10 and the event history tracking device 30.

As shown in FIG. 15, the event history storage device 10 and the event history tracking device 30 include a CPU 911 (Central Processing Unit, which is also referred to as a central processing device, a processing unit, an arithmetic operation unit, a microprocessor, a microcomputer, or a processor). The CPU 911 is connected to a ROM 913, a RAM 914, an LCD (Liquid Crystal Display) 901, a keyboard 902, a mouse 903, a communication board 915, and a magnetic disk device 920 through a bus 912, and controls these hardware devices. A storage device such as an optical device or a memory card read/write device may be employed in place of the magnetic disk device 920.

Each of the ROM 913 and the magnetic disk device 920 is an example of a nonvolatile memory. The RAM 914 is an example of a volatile memory. Each of the ROM 913, the RAM 914, and the magnetic disk device 920 is an example of the storage device. Each of the communication board 915 and the keyboard 902 is an example of an input device. The communication board 915 is an example of an output device. Further, the communication board 915 is an example of a communication device. Further, the LCD 901 is an example of a display device.

An operating system (OS) 921, a window system 922, programs 923, and files 924 are stored in the magnetic disk device 920 or the ROM 913. Programs of the programs 923 are executed by the CPU 911, the operating system 921, and the window system 922.

A program that executes functions explained as the “history data integration unit 11”, “element extraction unit 15”, “class information generation unit 16”, “instance information generation unit 17”, “order relationship storage unit 18”, “hierarchical relationship storage unit 19”, “related structure storage unit 20” and the like in the above description and the other programs are stored in the programs 923. Each program is read and executed by the CPU 911.

Information, data, signal values, variable values, and parameters explained as the “specified condition storage unit 12”, “integrated definition storage unit 13”, “integrated data storage unit 14”, “behavior index storage unit 21”, and the like in the above description are stored in respective items of “files” and “databases”. The “files” and the “databases” are stored in a recording medium such as a disk or a memory. The information, data, signal values, variable values, and parameters stored in the recording medium such as the disk or the memory are loaded into a main memory or a cache memory by the CPU 911 through a read/write circuit, and are used for operations of the CPU 911 such as extraction, search, reference, comparison, logical operation, computation, processing, output, printing, and display. During the operations of the CPU 911 such as extraction, search, reference, comparison, logical operation, computation, processing, output, printing, and display, the information, data, signal values, variable values, and parameters are temporarily stored in the main memory, cache memory, or a buffer memory.

An arrow portion of each flow chart in the above description mainly indicates input/output of data or a signal. The data or the value of the signal is stored in the memory of the RAM 914, and other recording mediums such as the optical disk. The data or signal is on-line transferred through the bus 912, signal lines, cables or the other transmission media.

Each of the components described as the “unit” in the above description may be a “circuit”, a “device”, an “apparatus”, “means”, or a “function”. Alternatively, the component may be a “step”, a “procedure”, or a “process”. Each of the components described as the “device” in the above description may be a “circuit”, a “device”, an “apparatus”, “means”, or a “function”. Alternatively, the component may be a “step”, a “procedure”, or a “process”. Each of the described “processes” may be a “step”. That is, each of the above-mentioned “units” may be implemented by a firmware stored in the ROM 913. Alternatively, each of the above-mentioned “units” may be implemented by only software, only hardware such as an element, a device, a substrate, and a wire, a combination of the software and the hardware, or a combination of the software and the firmware. The firmware and the software are stored in a recording medium such as the ROM 913, as a program. The program is read by the CPU 911, and is executed by the CPU 911. That is, the program causes a computer or the like to function, as the above-mentioned “unit”. Alternatively, the program causes the computer or the like to execute a procedure or a method of the above-mentioned “unit”.

### BRIEF DESCRIPTION OF THE DRAWINGS

FIG. 1 is a functional block diagram showing functions of an event history storage device 10;

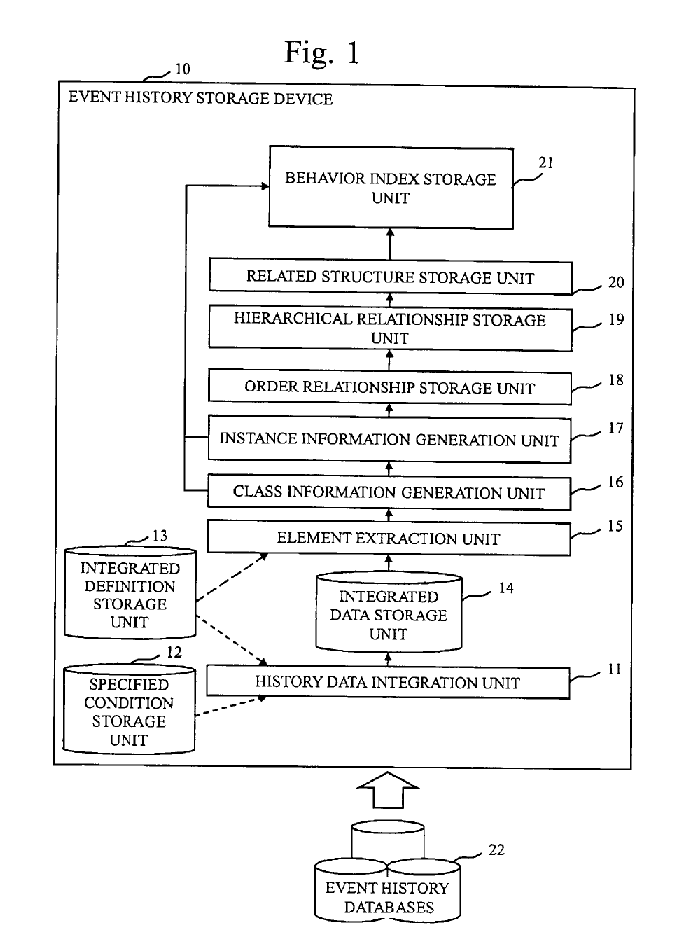

FIG. 2 is a diagram showing an example of a data format of integrated data;

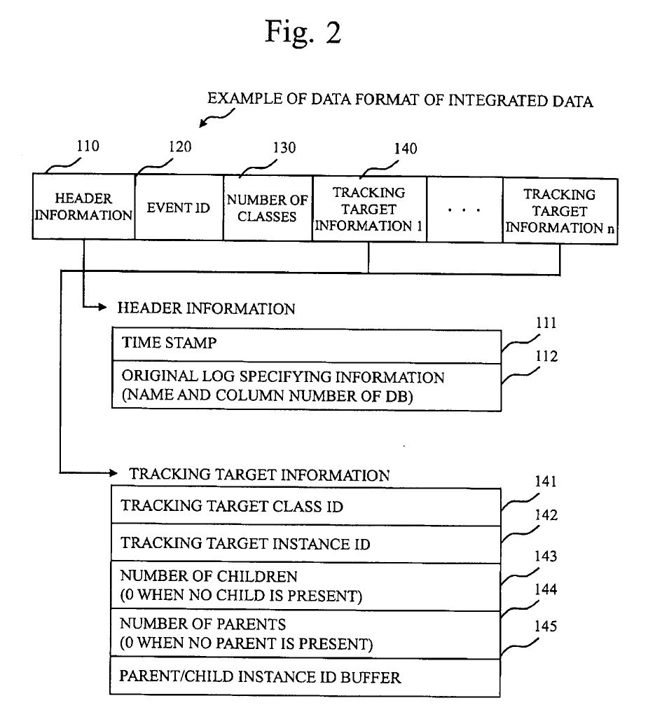

FIG. 3 is a diagram showing a structure of a data model managed by a behavior index storage device 21;

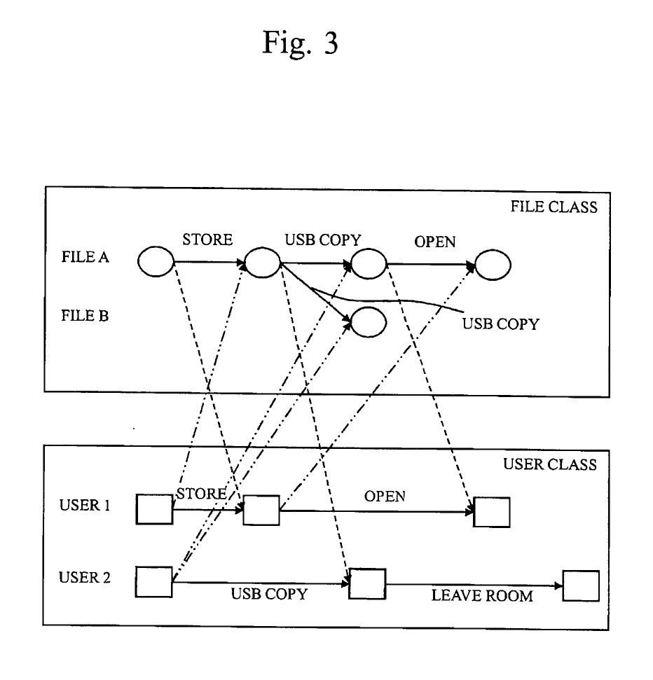

FIG. 4 is a diagram showing a data structure of a behavior index;

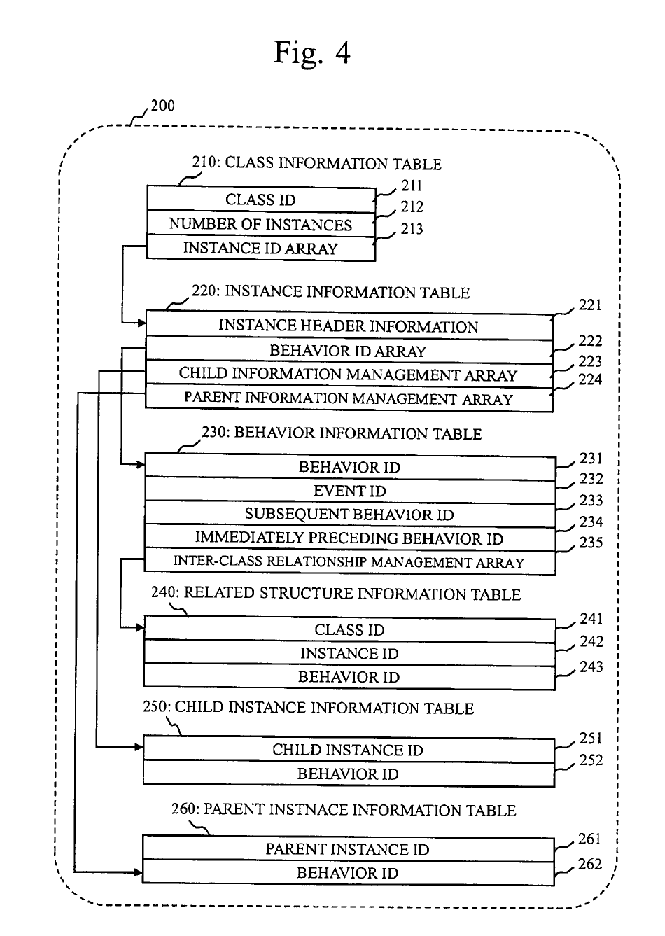

FIG. 5 is a flowchart showing an order-related information generation process by a class information generation unit 16, an instance information generation unit 17, and an order relationship storage unit 18;

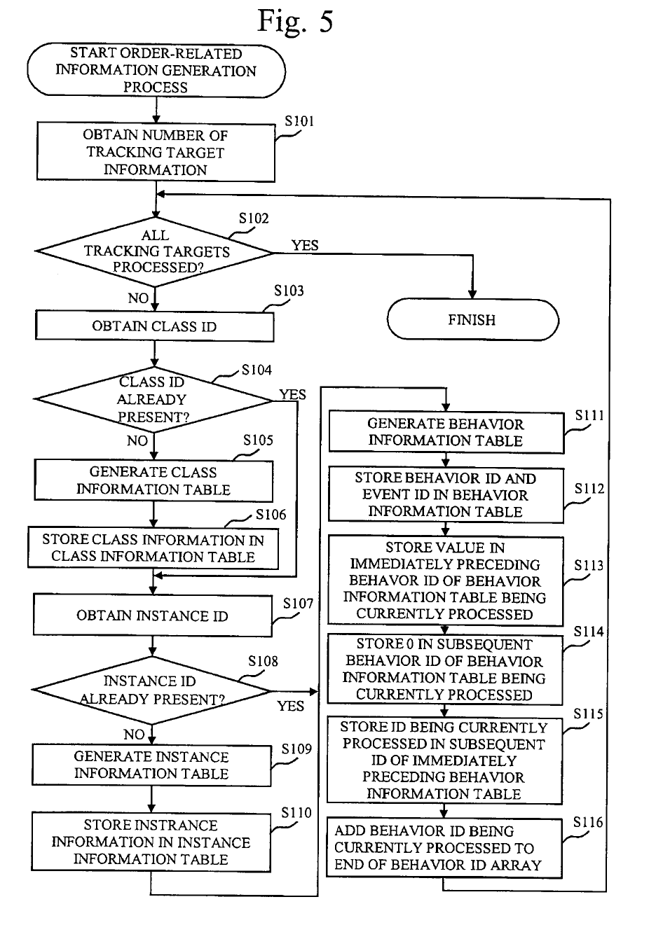

FIG. 6 is a flowchart showing a hierarchically related information generation process by a hierarchical relationship storage unit 19;

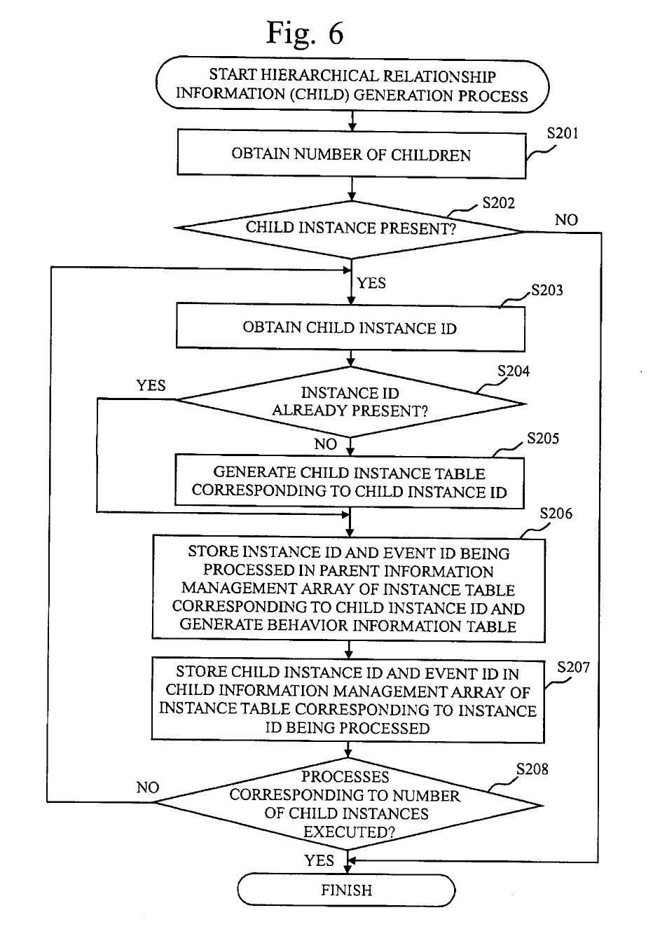

FIG. 7 is a flowchart showing a related structure information generation process by a related structure storage unit 20;

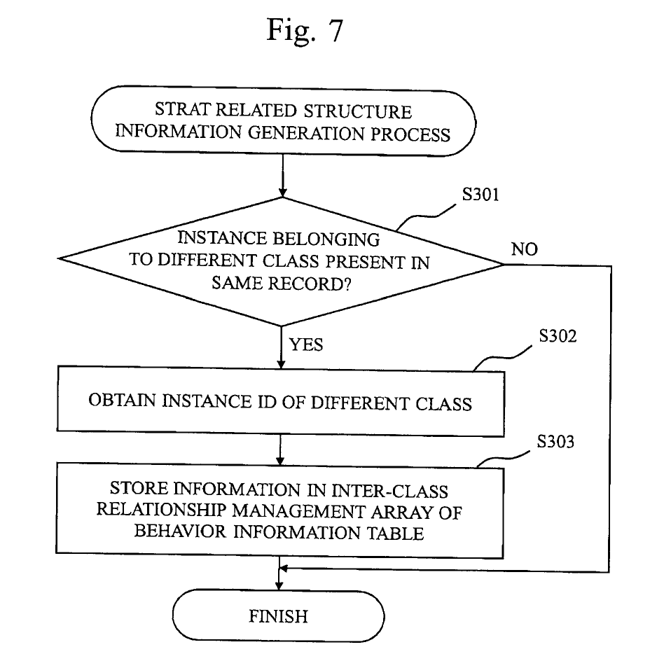

FIG. 8 is a functional block diagram showing a function of an event history tracking device 30;

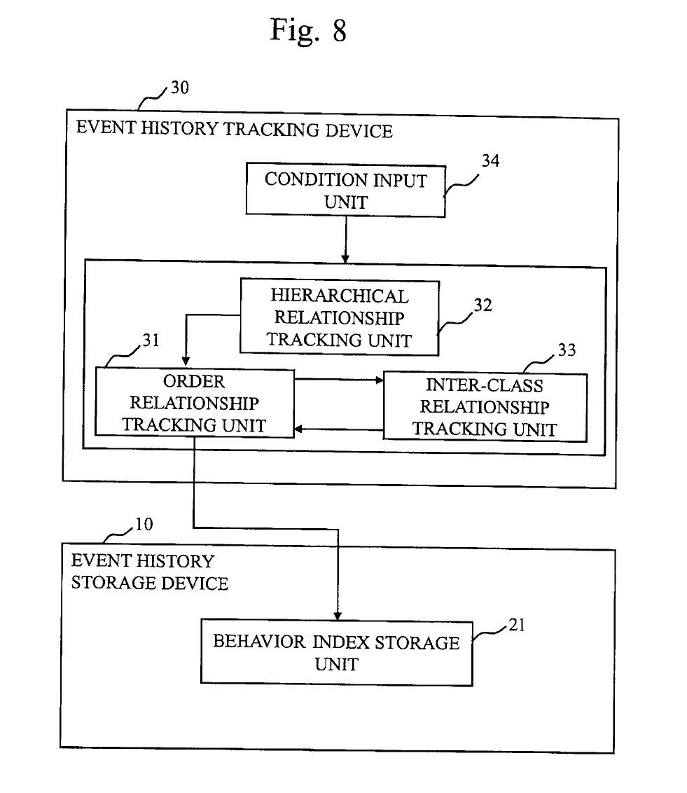

FIG. 9 is a diagram of an image of a mail transmission/reception history;

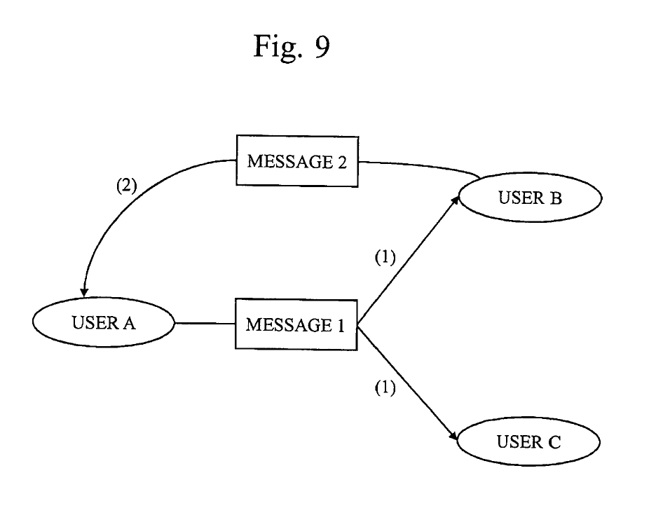

FIG. 10 is a diagram showing a structure of a data model of a behavior index for data on the mail transmission/reception history shown in FIG. 9;

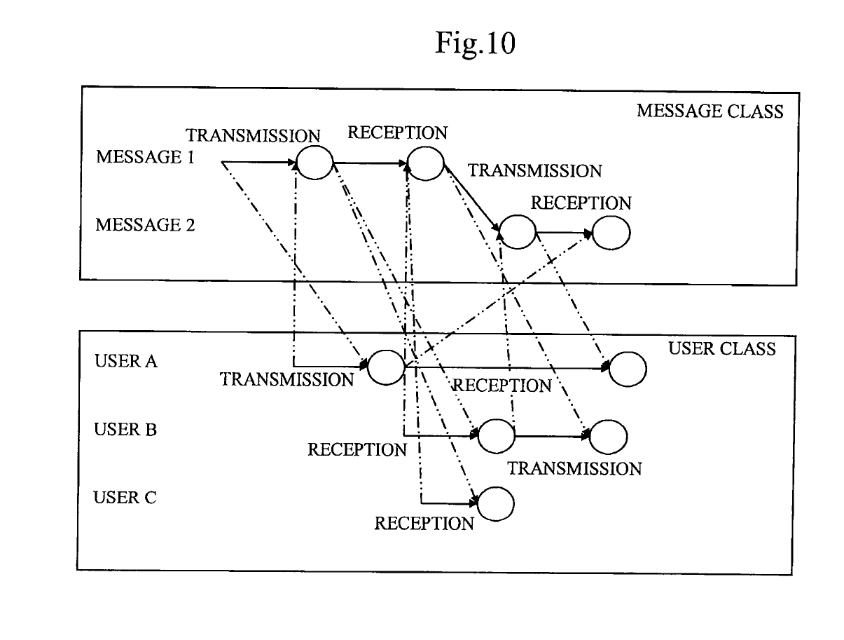

FIG. 11 is a flowchart showing an event history tracking process by the event history tracking device 30;

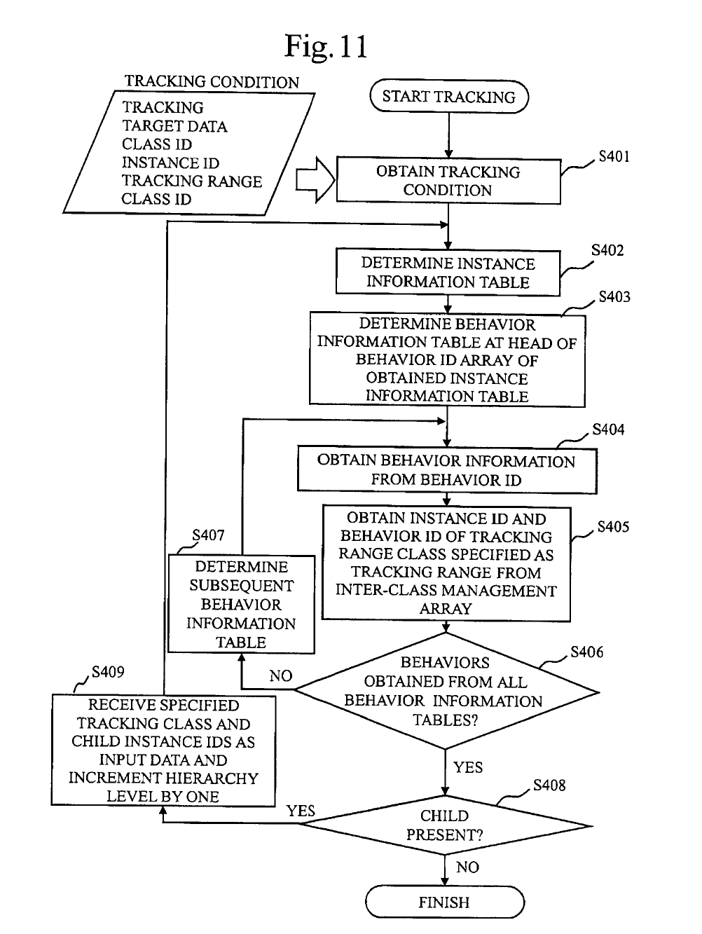

FIG. 12 is a flowchart showing a process of obtaining an instance which becomes a root;

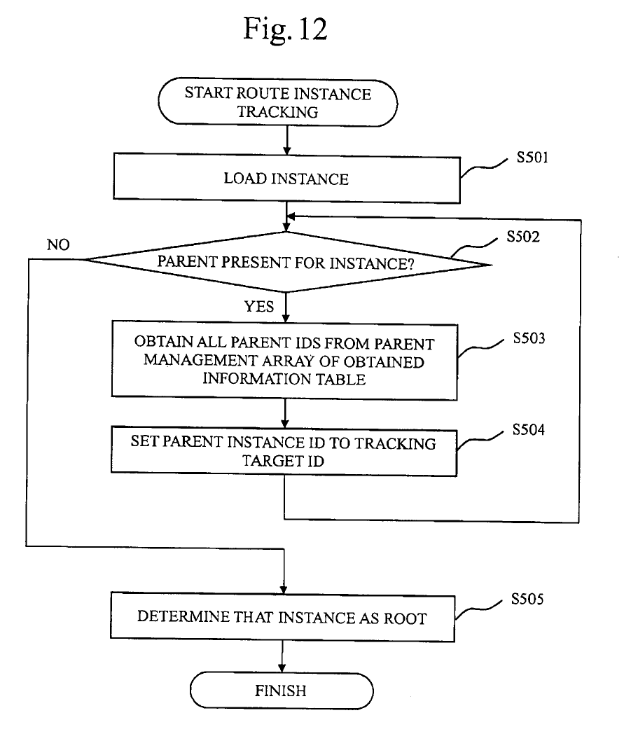

FIG. 13 is a diagram of an image of a manufacturing process;

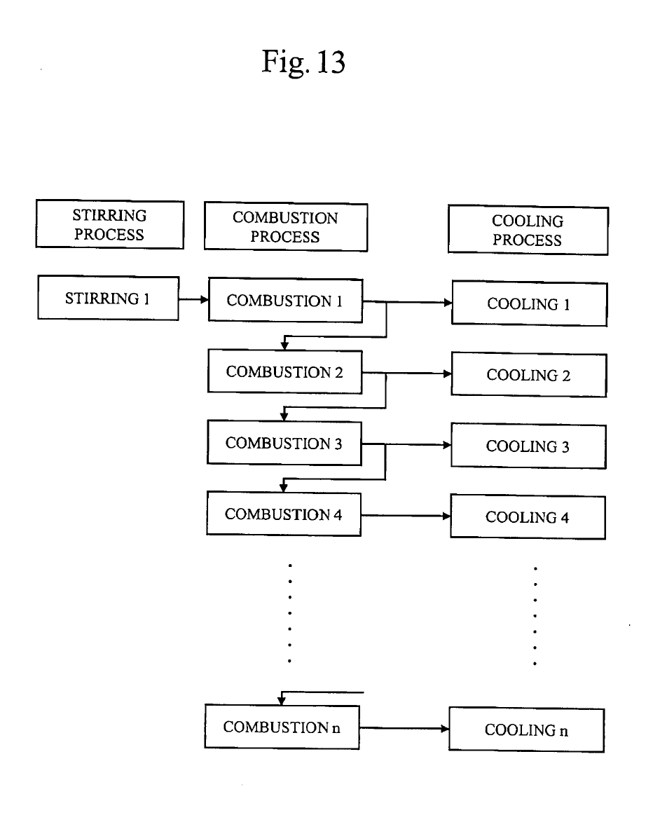

FIG. 14 is a flowchart showing an event history tracking process in which an event history is tracked up to a specified hierarchy level; and

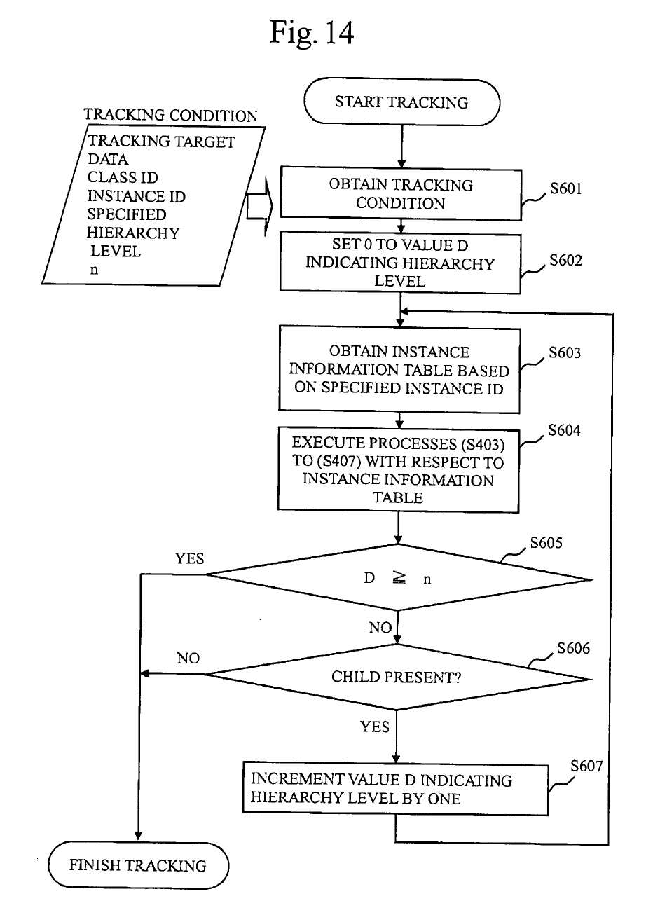

FIG. 15 is a diagram showing an example of a hardware configuration of the event history storage device 10 and the event history tracking device 30.

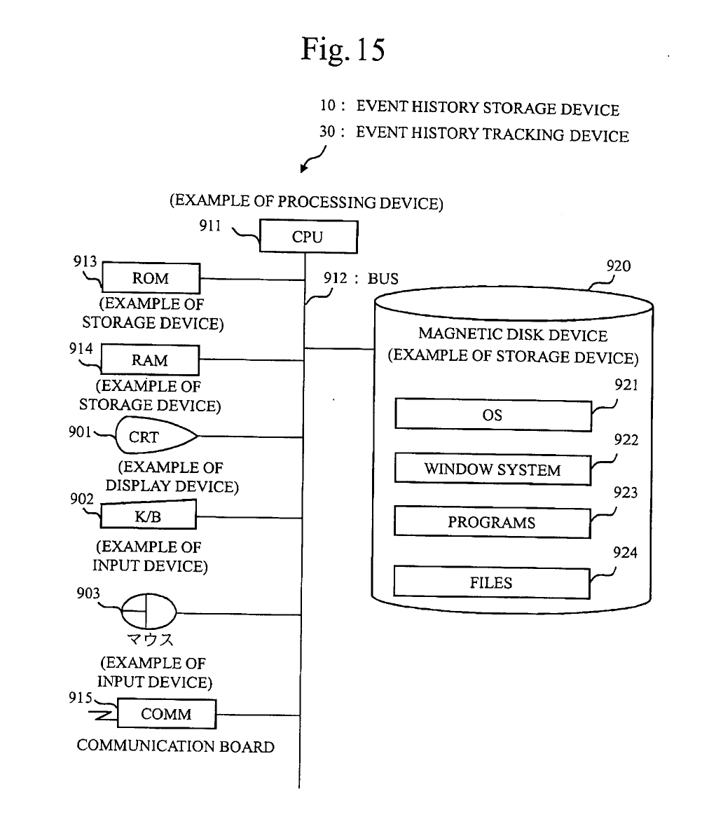

### DESCRIPTION OF REFERENCE SYMBOLS

10 event history storage device
11 history data integration unit
12 specified condition storage unit
13 integrated definition storage unit
14 integrated data storage unit
15 element extraction unit
16 class information generation unit
17 instance information generation unit
18 order relationship storage unit
19 hierarchy relationship storage unit
20 related structure storage unit
21 behavior index storage unit
22 event history database
30 event history tracking device
31 order relationship tracking unit
32 hierarchical relationship tracking unit
33 inter-class relationship tracking unit
34 condition input unit
110 header information
111 time stamp
112 original log specifying information
120 event ID
130 number of classes
140 tracking target information
141 tracking target class ID
142 tracking target instance ID
143 number of children
144 number of parents
145 parent/child instance ID buffer
200 behavior index
210 class information table
211 class ID
212 number of instances
213 instance ID array
220 instance information table
221 instance header information
222 behavior ID array
223 child information management array
224 parent information management array
230 behavior information table
231 behavior ID
232 event ID
233 subsequent behavior ID
234 immediately preceding behavior ID
235 inter-class relationship management array
240 related structure information table
241 class ID
242 instance ID
243 behavior ID
250 child instance information table
251 child instance ID
252 behavior ID
260 parent instance information table
261 parent instance ID
262 behavior ID

1. An event history storage device for storing histories of events which have occurred in an application, the event history storage device comprising:
an order relationship storage unit which assigns, for each instance belonging to a class targeted for tracking among classes each indicating a predetermined type, an identifier to an event that has occurred in association with the instance, and stores order-related information in a storage device, an occurrence order of the event which has occurred in association with the instance being represented by the identifier in the order-related information;
a hierarchical relationship storage unit which assigns a new identifier to the event with respect to a new instance when the new instance has been generated from the instance due to the event with the occurrence order thereof stored by the order relationship storage unit, and stores in the storage device hierarchically related information in which the new identifier and the identifier assigned to the event with respect to the instance that is a generation source for the event are associated; and
a related structure storage unit which stores in the storage device related structure information in which identifiers assigned to the same event with respect to the instance belonging to a different class by one of the order relationship storage unit and the hierarchical relationship storage unit are associated.

2. The event history storage device according to claim 1,
wherein the hierarchical relationship storage unit sets the new identifier assigned to the new instance as a child and sets the identifier assigned to the instance of the generation source as a parent, and stores the hierarchically related information in which the new identifier and the identifier assigned to the instance of the generation source are associated.

3. The event history storage device according to claim 1,
wherein the hierarchical relationship storage unit regards the new instance has been generated when the instance is divided, integrated, or replicated due to the event.

4. An event history tracking device for tracking an event history of a predetermined instance from the event histories stored in the event history storage device as set forth in claim 1, the event history tracking device comprising:
a condition input unit which inputs condition information that determines the instance targeted for tracking through an input device;
an order relationship tracking unit which obtains an event that has occurred in association with the instance determined by the condition information input by the condition input unit in an order indicated by the order-related information stored by the order relationship storage unit; and
a hierarchical relationship tracking unit which obtains an instance of a next hierarchy and an event that has occurred in association with the instance of the next hierarchy, the instance of a next hierarchy being a new instance that has been generated from the instance determined by the condition information or an instance from which the instance determined by the condition information has been generated, by tracking an identifier associated by the hierarchical relationship storage unit with an identifier assigned to the event obtained by the order relationship tracking unit.

5. The event history tracking device according to claim 4,
wherein the condition input unit inputs range information for narrowing down a tracking range to determine a class, together with the condition information; and
the event history tracking device further comprises:
an inter-class relationship tracking unit which obtains a different class instance related to the instance determined by the condition information and belonging to the class determined by the range information and an event that has occurred in association with the different class instance, by tracking an identifier associated by the related structure storage unit with an identifier assigned to the event obtained by the order relationship tracking unit and the hierarchical relationship tracking unit, the identifier being assigned to the instance belonging to the class indicated by the range information.

6. The event history tracking device according to claim 4,
wherein the hierarchical relationship tracking unit repeats a hierarchical relationship tracking process of obtaining an instance of a further next hierarchy and an event that has occurred in association with the instance of the further next hierarchy, by tracking an identifier associated by the hierarchical relationship storage unit with an identifier assigned to the instance of the next hierarchy.

7. The event history tracking device according to claim 4,
wherein the condition input unit inputs the condition information and hierarchy information indicating the number of hierarchies to be tracked; and
wherein the hierarchical relationship tracking unit repeats hierarchical relationship tracking processes corresponding to the number of hierarchies indicated by the hierarchy information and then finishes the hierarchical relationship tracking processes.

8. An event history storage method of storing histories of events which have occurred in an application, the event history storage method comprising:
an order relationship storage step of assigning, for each instance belonging to a class targeted for tracking among classes each indicating a predetermined type, an identifier to an event that has occurred in association with the instance by a processing device, and storing order-related information in a storage device, an occurrence order of the event which has occurred in association with the instance being represented by the identifier in the order-related information;
a hierarchical relationship storage step of assigning by the processing device a new identifier to the event with respect to a new instance when the new instance has been generated from the instance due to the event with the occurrence order thereof stored in the order relationship storage step, and storing by the storage device hierarchically related information in which the new identifier and the identifier assigned to the event with respect to the instance that is a generation source for the event are associated; and
a related storage step of storing by the storage device related structure information in which identifiers assigned to the same event with respect to the instance belonging to a different class in one of the order relationship storage step and the hierarchical relationship storage step are associated.

9. An event history storage program for storing histories of events which have occurred in an application, the event history storage program causing a computer to execute:
an order relationship storage process of assigning, for each instance belonging to a class targeted for tracking among classes each indicating a predetermined type, an identifier to an event that has occurred in association with the instance, and storing in a storage device order-related information, an occurrence order of the event which has occurred in association with the instance being represented by the identifier in the order-related information;
a hierarchical relationship storage process of assigning a new identifier to the event with respect to a new instance when the new instance has been generated from the instance due to the event with the occurrence order thereof stored in the order relationship storage process, and storing in the storage device hierarchically related information in which the new identifier and the identifier assigned to the event with respect to the instance that is a generation source for the event are associated; and
a related structure storage process of storing in the storage device related structure information in which identifiers assigned to the same event with respect to the instance belonging to a different class in one of the order relationship storage process and the hierarchical relationship storage process are associated.

10. A data structure for storing histories of events which have occurred in an application, the data structure comprising:
an instance information storage region comprising a storage region in which information is stored for each instance belonging to a class targeted for tracking, the class targeted for tracking being one of classes each indicating a predetermined type;
the storage region for each instance including:
a behavior identifier storage region including a storage region for each event which has occurred in association with the instance, the storage region for each event storing a behavior identifier assigned to the instance and an event which has occurred in association with the instance, and at least one of behavior identifiers assigned to events which have occurred in association with the instance before and after the event with the behavior identifier assigned thereto; and
at least one of a child instance storage region and a parent instance storage region, the child instance storage region storing an instance identifier that identifies a new instance generated from the instance and a behavior identifier assigned to the new instance with respect to an event due to which the new instance has been generated, the parent instance storage region storing an instance identifier that identifies the instance from which the new instance has been generated and a behavior identifier assigned to the instance with respect to the event due to which the instance has been generated;
the storage region for each event in the behavior identifier storage region including:
a related structure storage region storing a behavior identifier assigned to an instance belonging to a different class, with respect to the event which has occurred in association with the event.
